(19) United States
(12) Patent Application Publication
(10) Pub. No.: US 2007/0145029 A1
(43) Pub. Date: Jun. 28, 2007

(54) SOLID WIRE FOR GAS SHIELDED ARC WELDING

(76) Inventor: Byung Ho Park, Changwon-si (KR)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/539,643

(22) Filed: Oct. 8, 2006

(30) Foreign Application Priority Data
Nov. 23, 2005 (KR) 10-2005-112305

(51) Int. Cl. B23K 35/02

(52) U.S. Cl. 219/145.31

(57) ABSTRACT

Provided is a solid wire for gas shielded arc welding having good feedability and arc stability. The wire is provided to have a hardening factor between 0.25 and 0.55.

This application claims the benefit of Korean Application No. 10-2005-112305 which was filed on Nov. 23, 2005, which is hereby incorporated by reference as if fully set forth herein.

### BACKGROUND OF THE INVENTION

1. Field of the Invention

The present invention relates to a solid wire for gas shielded arc welding, and more particularly, to a solid wire for gas shielded arc welding capable of increasing feedability of a welding wire during welding to improve arc stability.

2. Description of the Related Art

When welding is performed using welding wire, arc stability is a very important factor for obtaining good welding quality and smooth welding beads. Especially, in order to improve arc stability, feedability of the welding wire should be improved.

When welding is performed using conventionally available welding wire, i.e., a spool 105 and a pail pack 104, as shown in FIG. 1, the welding wire is conveyed to a welding part via a feeding cable 102 through a contact tip, thereby performing the welding using arc heat generated at an end of the contact tip.

At this time, the welding wire is in contact with an inner wall of the feeding cable 102 and the contact tip, and feed resistance generated at the contact part largely affects feedability. In consideration of feed resistance generated at the contact part between the welding wire and the feeding cable 102 and the contact tip, and the resulting decrease in feedability, it is clear that mechanical properties of the welding wire are very important factors. Strength of the welding wire can be increased by limiting tensile strength of the conventional welding wire, variation of the tensile strength, a yield ratio, an elastic limit ratio (elastic limit ratio=elastic limit/tensile strength), and/or the amount of a surface treatment agent used, thereby improving feedability of the welding wire during welding. The above parameters are extracted using a stress-strain curve observed during a tensile test. However, the parameter formulas of the conventional art do not perfectly represent wire properties, thereby making it difficult to control welding wire feedability and arc stability.

### SUMMARY OF THE INVENTION

The present invention solves the aforementioned problems by providing a solid wire for gas shielded arc welding capable of optimally managing a hardening factor that precisely represents a strain hardening rate of a welding wire to improve feedability of the welding wire during welding and therefore improve arc stability.

According to an aspect of the present invention, a completed solid wire for gas shielded arc welding has a hardening factor, defined by the following Formula 1, within a range of 0.25-0.55,

[Formula 1]
hardening factor=(maximum tensile strength−yield strength)/yield strength

wherein, the yield strength represents 0.05% offset yield strength.

In this process, the wire may consist of 0.03-0.10 wt % C, 0.45-1.05 wt % Si, 0.90-1.90 wt % Mn, 0.030 wt % or less P, 0.030 wt % or less S, and residual Fe and other impurities.

In addition, the hardening factor of the solid wire for gas shielded arc welding may be controlled by a combination of at least one selected from a bending roller and an inclined straightening roller after a final drawing process, and longitudinal/lateral straightening rollers.

### BRIEF DESCRIPTION OF THE DRAWINGS

The above and other objects, features and advantages of the present invention will become more apparent by describing certain exemplary embodiments of the invention with reference to the attached drawings, in which:

FIG. 1 is a schematic view of a feeding line of a welding wire;

FIG. 2 is a graph showing a strain hardening rate deduced from a stress-strain curve observed during a tensile test;

FIG. 3 is a stress-strain curve observed during a tensile test;

FIG. 4 is a graph showing a hardening factor of a copper plated wire, standard deviation of welding current, and tensile strength of the wire;

FIG. 5 is a perspective view of bending rollers adapted after a final drawing in accordance with a first exemplary embodiment of the present invention;

FIGS. 6 and 7 are perspective views of straightening rollers inclined from a horizontal surface by 45° in accordance with an exemplary embodiment of the present invention; and

FIG. 8 is a perspective view showing longitudinal/lateral straightening rollers in accordance with an exemplary embodiment of the present invention.

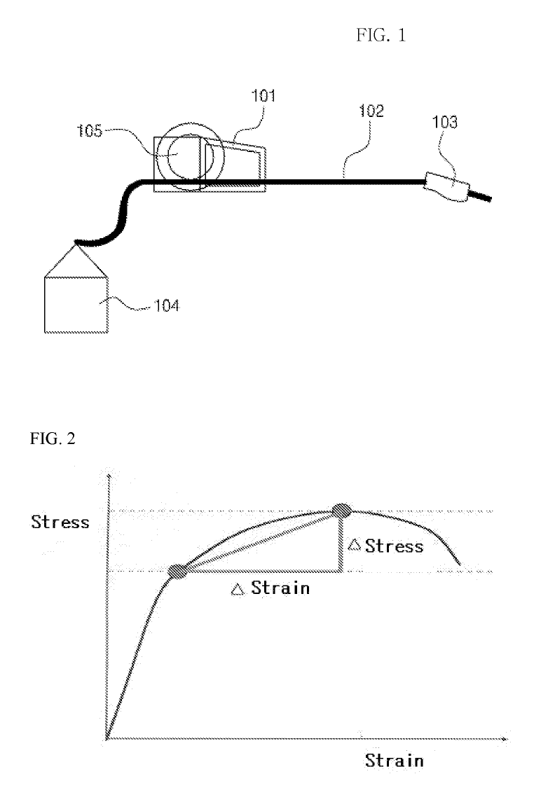

### DETAILED DESCRIPTION OF THE INVENTION

Hereinafter, exemplary embodiments of the present invention will be described in detail.

First, extraction of a hardening factor, proposed as a novel parameter capable of representing tensile strength and a strain hardening rate of a wire, will be described.

As described above, the inventor has attempted to extract the tensile strength of the welding wire capable of maintaining welding wire feedability and arc stability during welding in an optimal state, and manage the tensile strength, in consideration of the fact that the tensile strength of the welding wire largely affects the feedability and arc stability during welding.

Thus, a drawing method, a drawing speed, and a straightening method of the wire before winding it on a spool or a pail pack are varied using an original rod having the same chemical composition, to observe variation in tensile strength of the completed wire, and perform a test of feedability and arc stability according to tensile strength of the wire.

At this time, it was observed that there is a difference between the feedability and arc stability of wires having similar tensile strengths during welding. In order to understand this result, a stress-strain curve obtained through a tension test of the wires was analyzed.

As a result, it was observed from the stress-strain curve that while the tensile strengths are similar, the yield strengths are different.

The following Table 1 shows the relationship between the yield strength and tensile strength of the welding wires having different feedability and arc stability during welding of copper plated wires having a tensile strength range of 126 kgf/mm²-132 kgf/mm².

TABLE 1

| | | | Yield | |
|---|---|---|---|---|
| | | Arc | strength | Tensile strength |
| Classification | Feedability | stability | (kgf/mm²) | (kgf/mm²) |
| 1 | x | x | 104.3 | 126.2 |
| 2 | □ | x | 103.6 | 126.4 |
| 3 | ∘ | ∘ | 94.8 | 128.1 |
| 4 | ∘ | ∘ | 89.2 | 131.2 |
| 5 | ∘ | ∘ | 87.1 | 131.5 |
| 6 | □ | □ | 83.5 | 130.3 |
| 7 | x | x | 83.5 | 132.0 |
| 8 | x | x | 79.3 | 126.1 |

Here, the yield strength represents 0.05% offset yield strength.

As shown in Table 1, even when the tensile strengths are uniform, it will be appreciated that the welding wire feedability and arc stability during welding vary according to the yield strength.

That is, good feedability and arc stability during welding can be obtained by managing tensile strength and a strain hardening rate within an appropriate range as well as simply adjusting the tensile strength. This concept will be represented as a hardening factor herein.

In this process, the strain hardening rate is the ratio of stress increase from a yield point to a maximum tensile strength (□stress/□strain), a graph of which is shown in FIG. 2.

For example, though the wires have the same tensile strengths, their strain hardening rates may be varied by external forces applied to the wires during straightening through straightening rollers before winding on a spool or a pail pack, thereby varying properties of the wires. That is, the external force applied to the wires makes their strain hardening rates vary such that properties of the wires vary with the yield strength, though the wires have the same tensile strength.

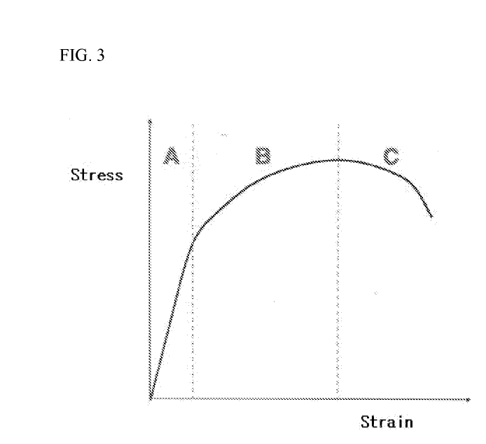

Referring to the stress-strain curve observed during a tensile test shown in FIG. 3 for understanding the hardening factor, it will be appreciated that the stress in an elastic region is directly proportional to the strain in the same region (A region).

When a load is larger than a value corresponding to the yield strength, a plastic deformation is generated. Then, when the plastic deformation is continuously generated, strain hardening occurs to increase stress as the plastic deformation rate increases. Since the volume of the tensile test specimen is uniform during the plastic deformation, i.e., the following Formula 2 is satisfied, the test specimen's cross-sectional area decreases as its length increases.

[Formula 2]
AL=AoLo,

wherein A represents the cross-sectional area of the test specimen during the tensile test, L represents the length of the test specimen, Ao represents the initial cross-sectional area of the test specimen, and Lo is the initial length of the test specimen.

Though the initial strain hardening is larger than compensation from reduction of the cross-sectional view area, and stress continuously increases as strain increases, after the initial strain hardening, reduction of the cross-sectional area of the test specimen becomes larger than increase in strain load due to the strain hardening.

This condition is generated from a weak point of the test specimen. Then, the plastic deformation is concentrated at B region, and the test specimen may be necked or locally thinned at the B region.

From this point, since the cross-sectional area of the test specimen is sharply decreased in comparison with increase in strain load due to strain hardening, an actual load required for deformation of the specimen is decreased, and stress is continuously reduced until breakage (C region).

As described above, the strain hardening rate most largely affects the tensile strength of the specimen, and the resultant strength of the specimen is determined according to the strain hardening rate.

Hereinafter, a method of extracting a hardening factor, and reasons for limiting a range, will be described in detail.

The hardening factor is a scale for representing a strain hardening rate deduced from a stress-strain curve observed during a tensile test, and is defined by the following Formula 1.

[Formula 1]
Hardening factor=(maximum tensile strength−yield strength)/yield strength

wherein, the yield strength represents 0.05% offset yield strength.

A tensile test is performed on a wire on the basis of KS B 0802. A maximum tensile strength and a yield strength are taken from a stress-strain curve extracted from the tensile test results to calculate the hardening factor. The hardening factor calculated in this way may be managed within a range of 0.25-0.55.

If the hardening factor is lower than 0.25, since an elastic deformation section of a wire is too much wider than a plastic deformation section, when a feed load is high, i.e., when performing high-current or high-speed welding, the wire may not be readily deformed according to the shape of a feed cable. In addition, since elasticity of the wire is strong, a large strain force must be applied to wind the wire on a spool and a pail pack, and the resultant wound wire has excessive elastic force. Therefore, a large contact resistance is generated when the wire passes through the cable and the contact tip during welding, and feedability may be unstable and deteriorate arc stability.

In addition, if the hardening factor is higher than 0.55, since an elastic deformation section of a wire is too much narrower than a plastic deformation section, when a feed load is high, i.e., when performing high-current or high-speed welding, the wire may be too readily deformed according to the shape of a feed cable. Therefore, the wire is easily bent when it passes through the cable, and feed resistance increases in the contact tip. In addition, straightness of the wire deteriorates, lowering feedability and arc stability.

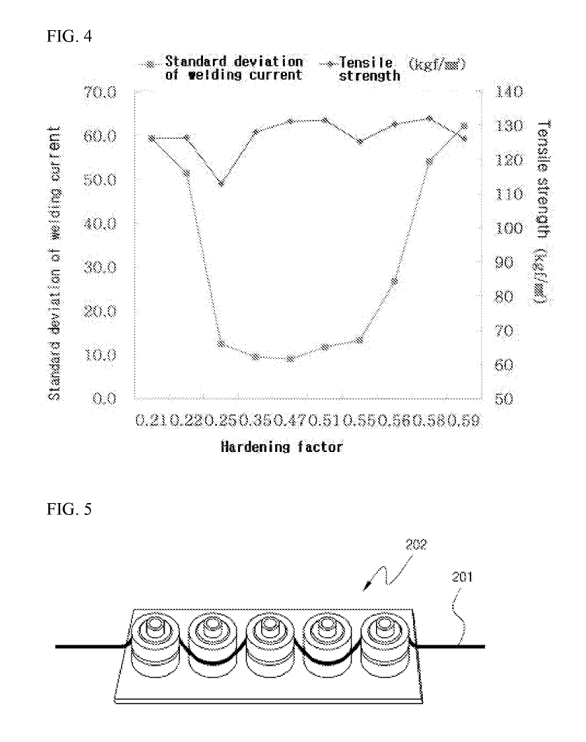

FIG. 4 is a graph showing a hardening factor of a copper plated wire, standard deviation of welding current, and tensile strength of the wire. When the hardening factor is within the range of 0.25-0.55, it will be appreciated that standard deviation of welding current is very low.

The wire may or may not be copper plated and its composition may be a generally used composition. Specifically, the wire may consist of 0.03-0.10 wt % C, 0.45-1.05 wt % Si, 0.90-1.90 wt % Mn, 0.030 wt % or less P, 0.030 wt % of less S, and residual Fe or other impurities. In addition, if necessary, Cu or Ti may be added.

Here, C is an element for improving the strength of a welding wire and a deposited metal. When the content of C in the wire is increased, spatter generation increases during welding. When the content of C is lower than 0.03 wt %, the strength of the welding wire and the deposited metal is too low, and when the content of C is higher than 0.10 wt %, spatter generation increases during welding.

Si is an essential element for improving the fluidity of melted metal to increase spreadability of welding beads during welding and strength of the metal. In addition, Si helps deoxidation of the melted metal to form slag on the welded metal. When the content of Si is lower than 0.45 wt %, the tensile strength of the welding wire and the deposited metal, and the fluidity of the melted metal, are decreased, and when the content of Si is higher than 1.05 wt %, bead sagging during high current welding and fluidity of droplets during welding are increased to cause the droplets to shake, thereby reducing arc stability.

Mn also helps deoxidation of the melted metal to form slag on the welded metal and improve strength of the welding wire and the deposited metal, similar to Si. When the content of Mn is lower than 0.90 wt %, it is impossible to obtain tensile strength of the welding wire and an appropriate surface tension of the deposited metal, and when the content of Mn is higher than 1.90 wt %, an amount of active oxygen in droplets during welding decreases, increasing surface tension of the droplets.

P exists in the metal as an impurity and lowers melting point, thereby increasing high-temperature crack sensitivity. When the content of P is higher than 0.030 wt %, high-temperature cracks may be generated.

S also lowers melting point to increase high-temperature crack sensitivity, similar to P. When the content of S is higher than 0.030 wt %, high-temperature cracks may be generated.

A method of controlling tensile strength and a hardening factor during manufacture of a welding wire will be described below. The tensile strength of the welding wire may be affected by chemical composition, drawing method, drawing speed, and so on, of an original rod.

The drawing method may be generally divided into a two-step drawing method and an inline drawing method. First, the two-step drawing method includes processes of acid pickling, primary drawing, heat treatment for removing stress, acid pickling, secondary drawing, degreasing, (plating), and third drawing (including skin pass). Second, the inline drawing method includes processes of acid pickling, primary drawing, (plating), and secondary drawing. Here, the two-step drawing method having the heat treatment process has a lower tensile strength than the inline drawing method due to stress removal. In addition, the faster the drawing speed, the higher the workability, and thus the higher the tensile strength. In the case of the two-step drawing method, a secondary drawing speed should be managed at a low speed, as a primary drawing speed is faster. In the case of the inline drawing method, drawing speed of a copper plated wire should be managed at 1500 m/min or less, and drawing speed of a non-plated wire should be managed at 1000 m/min or less. As described above, it is possible to manage the drawing method and the drawing speed to control the tensile strength.

In addition, the hardening factor of the resultant wire is controlled by bending rollers and straightening rollers used for straightening the wire before winding it on a spool or a pail pack after final drawing. Specifically, the hardening factor is controlled by 1) a combination of bending rollers and longitudinal/lateral rollers, 2) a combination of straightening rollers inclined from a horizontal surface by 45° (hereinafter, referred to as “inclined straightening rollers”) and the longitudinal/lateral rollers, 3) a combination of the bending rollers, the inclined straightening rollers, and the longitudinal/lateral rollers, or the like.

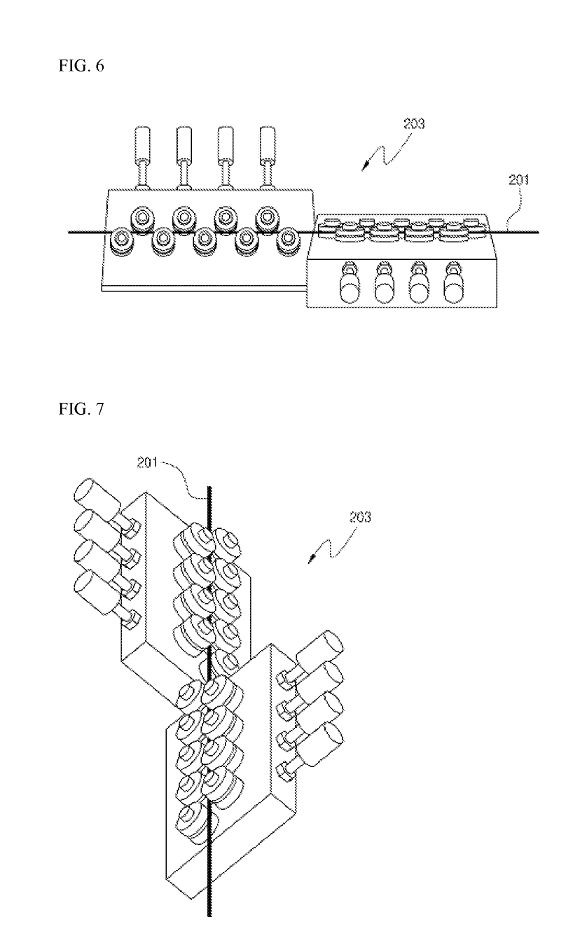

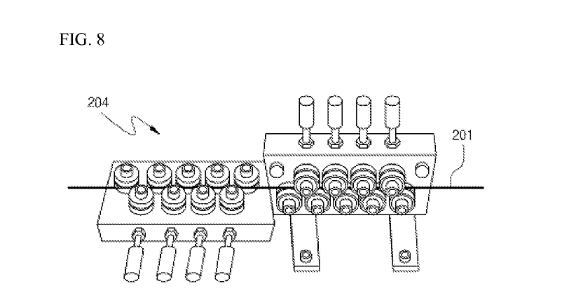

FIG. 5 illustrates the bending rollers, FIGS. 6 and 7 illustrate the inclined straightening rollers, and FIG. 8 illustrates the longitudinal/lateral rollers. The bending rollers shown in FIG. 5 slightly increase the tensile strength of the wire. Especially, the heat-treated wire has a higher tensile strength. In addition, increase in tensile strength causes increase in hardening factor, since the bending roller causes strain hardening of the wire to increase the strain hardening rate.

The inclined straightening rollers shown in FIGS. 6 and 7 function to straighten the finally drawn wire, thereby increasing the hardening factor.

The longitudinal/lateral straightening rollers shown in FIG. 8 also function to straighten the finally drawn wire, but do not largely affect the hardening factor. While the longitudinal/lateral straightening rollers may not affect the hardening factor by themselves, together with the inclined straightening rollers they may increase the hardening factor.

### Embodiment

Hereinafter, an exemplary embodiment in accordance with the present invention will be described in detail for the sole purpose of fully enabling practice of the invention, not limiting its scope.

Method of Evaluating Feedability of Welding Wire

Table 2 shows chemical composition of a welding wire used in the present invention, and Table 3 shows welding conditions. As shown in Table 2, the welding wire includes a copper plated wire and a non-plated wire.

TABLE 2

| Clas- | | Wire composition (wt %) | | | | | | |
|---|---|---|---|---|---|---|---|---|
| sification | Type | C | Si | Mn | P | S | Cu | Ti |
| YGW 11 | Copper | 0.05 | 0.88 | 1.52 | 0.012 | 0.006 | 0.25 | 0.19 |
| | plated | | | | | | | |
| | Non- | 0.06 | 0.79 | 1.57 | 0.016 | 0.011 | 0.01 | 0.16 |
| | plated | | | | | | | |
| YGW 12 | Copper | 0.06 | 0.86 | 1.50 | 0.018 | 0.009 | 0.23 | — |
| | plated | | | | | | | |
| | Non- | 0.07 | 0.85 | 1.52 | 0.014 | 0.012 | 0.01 | — |
| | plated | | | | | | | |

TABLE 3

| Wire | | | | | Gas | |
|---|---|---|---|---|---|---|
| di- | | Welding | Welding | Shielding | flow | Cable |
| ameter | Polarity | current | voltage | gas | rate | length |
| 1.2 mm | DC-EP | 300 A | 34 V | CO₂ 100% | 201/min | 5 m |

The feedability of the wire is evaluated using evaluation standards shown in Table 4. Here, “Possible” means that the welding is continuously maintained for 60 seconds or more under the conditions of Table 3, and “Impossible” means that the welding cannot be continuously maintained for more than 60 seconds.

TABLE 4

| | |
|---|---|
| Evaluation | Feed cable condition |

| symbol | W | 1 turn | 2 turns | Evaluation |
|---|---|---|---|---|
| ∘ | Possible | Possible | Possible | Good |
| □ | Possible | Possible | Impossible | Normal |
| x | Possible | Impossible | Impossible | Poor |

Method of Evaluating Arc Stability During Welding

Welding is performed under the welding conditions shown in Table 5, and the arc stability of the welding wire is evaluated using the method shown in Table 6.

Both the copper plated wire and the non-plated wire of Table 2 were used as the welding wire. Inline automatic welding was performed for 20 seconds under the welding conditions of Table 5, and monitored 5000 times per second using an arc monitoring system (WAM400D Ver. 2.0).

TABLE 5

| Welding condition | | | Welding type |
|---|---|---|---|
| Welding | Welding | Welding speed | Bead on plate |
| current 300 A | voltage 32 V | 40 CPM | |
| Shielding gas | Gas flow rate | CTWD | |
| CO₂ 100% | 20 l/min | 15-20 mm | |

Here, standard deviation of the welding current is used to evaluate arc stability as shown in Table 6. Referring to Table 6, when there is no arc cut and the standard deviation of the welding current is less than 15, a small amount of spatter is generated and a smooth bead shape can be obtained. On the other hand, when the arc cut is more than two times and the standard deviation of the welding current is more than 50, spatter generation amount and bead shape are both poor.

TABLE 6

| | | | Standard | |
|---|---|---|---|---|
| Evaluation | Monitoring | | deviation of | |
| symbol | time (second) | Arc cut | welding current | Evaluation |
| ∘ | 20 | None | Less than 15 | Good |
| □ | 20 | 1 time or less | 15-50 | Normal |
| x | 20 | 2 times or more | More than 50 | Poor |

Results of Tables 1 to 6 are arranged in Tables 7 and 8. Here, Table 7 lists manufacturing methods according to wire type, and methods of applying bending rollers and straightening rollers after final drawing. Table 8 lists evaluation of hardening factor, feedability, and arc stability of the resulting wires manufactured through the methods of Table 7.

TABLE 7

| | | | | | A: Bending rollers | |
|---|---|---|---|---|---|---|
| | | Primary | | Secondary | B: Inclined straightening | |
| | | drawing | | drawing | rollers | |
| | | speed | Heat | speed | C: Longitudinal/lateral | Product |
| No. | Manufacturing method | (m/min) | treatment | (m/min) | straightening rollers | type |
| CE 1 | Inline | ≦1500 | x | — | — | Copper |
| | | | | | | plated |
| CE 2 | Inline | ≦1500 | x | — | C | Copper |
| | | | | | | plated |
| CE 3 | 2-Step drawing | 1000-1500 | ∘ | ≦400 | — | Copper |
| | | | | | | plated |
| CE 4 | 2-Step drawing | 1000-1500 | ∘ | ≦400 | C | Copper |
| | | | | | | plated |
| IE 1 | 2-Step drawing | 500-1000 | ∘ | ≦600 | B + C | Copper |
| | | | | | | plated |
| IE 2 | Inline | ≦1500 | x | — | B + C | Copper |
| | | | | | | plated |
| IE 3 | 2Step drawing | 1000-1500 | ∘ | ≦400 | A + C | Copper |
| | | | | | | plated |
| IE 4 | 2-Step drawing | 500-1000 | ∘ | ≦600 | A + C | Copper |
| | | | | | | plated |
| IE 5 | Inline | ≦1500 | x | — | A + C | Copper |
| | | | | | | plated |
| IE 6 | Inline | ≦1500 | x | — | A + B + C | Copper |
| | | | | | | plated |
| IE 7 | 2-Step drawing | 1000-1500 | ∘ | ≦400 | A + B + C | Copper |
| | | | | | | plated |
| CE 5 | Inline | ≧1500 | x | — | B + C | Copper |
| | | | | | | plated |
| CE 6 | 2-Step drawing | 500-1000 | ∘ | ≦400 | A + B + C | Copper |
| | | | | | | plated |
| CE 7 | Inline | ≧1500 | x | — | A + C | Copper |
| | | | | | | plated |
| CE 8 | 2-Step drawing | 1000-1500 | ∘ | ≦600 | A + C | Copper |
| | | | | | | plated |
| CE 9 | Inline | ≧1500 | x | — | A + B + C | Copper |
| | | | | | | plated |
| CE 10 | Inline | ≦1000 | x | — | C | Non-plated |
| CE 11 | 2-Step drawing | 500-1000 | ∘ | ≦600 | — | Non-plated |
| IE 8 | 2-Step drawing | 500-1000 | ∘ | ≦600 | B + C | Non-plated |
| IE 9 | Inline | ≦1000 | x | — | B + C | Non-plated |
| IE 10 | 2-Step drawing | 1000-1500 | ∘ | ≦400 | A + C | Non-plated |
| IE 11 | 2-Step drawing | 500-1000 | ∘ | ≦600 | A + C | Non-plated |
| IE 12 | Inline | ≦1000 | x | — | A + C | Non-plated |
| IE 13 | Inline | ≦1000 | x | — | A + B + C | Non-plated |
| IE 14 | 2-Step drawing | 1000-1500 | ∘ | ≦400 | A + B + C | Non-plated |
| IE 15 | 2-Step drawing | 500-1000 | ∘ | ≦600 | A + B + C | Non-plated |
| CE 12 | 2-Step drawing | 500-1000 | ∘ | ≦400 | A + C | Non-plated |
| CE 13 | Inline | ≧1000 | x | — | B + C | Non-plated |
| CE 14 | 2-Step drawing | 1000-1500 | ∘ | ≦600 | A + B + C | Non-plated |
| CE 15 | Inline | ≧1000 | x | — | A + C | Non-plated |

* CE: Comparative example,
IE: Invention example.

TABLE 8

| | Yield | Tensile | | | |
|---|---|---|---|---|---|
| No. | strength(kgf/mm²) | strength(kgf/mm²) | Hardening factor | Feedability | Arc stability |
| CE 1 | 104.3 | 126.2 | 0.21 | x | x |
| CE 2 | 103.6 | 126.4 | 0.22 | □ | x |
| CE 3 | 98.8 | 121.5 | 0.23 | □ | □ |
| CE 4 | 98.9 | 122.6 | 0.24 | □ | □ |
| IE 1 | 90.3 | 112.9 | 0.25 | ∘ | ∘ |
| IE 2 | 94.8 | 128.1 | 0.35 | ∘ | ∘ |
| IE 3 | 90.8 | 123.3 | 0.36 | ∘ | ∘ |
| IE 4 | 83.4 | 114.3 | 0.37 | ∘ | ∘ |
| IE 5 | 89.2 | 131.2 | 0.47 | ∘ | ∘ |
| IE 6 | 87.1 | 131.5 | 0.51 | ∘ | ∘ |
| IE 7 | 80.8 | 125.2 | 0.55 | ∘ | ∘ |
| CE 5 | 83.5 | 130.3 | 0.56 | □ | □ |
| CE 6 | 72.7 | 114.2 | 0.57 | □ | x |
| CE 7 | 83.5 | 132.0 | 0.58 | x | x |
| CE 8 | 79.3 | 126.1 | 0.59 | x | x |
| CE 9 | 83.4 | 133.4 | 0.60 | x | x |
| CE 10 | 102.3 | 123.8 | 0.21 | x | x |
| CE 11 | 91.4 | 113.3 | 0.24 | □ | x |
| IE 8 | 90.9 | 113.6 | 0.25 | ∘ | ∘ |
| IE 9 | 95.5 | 126.1 | 0.32 | ∘ | ∘ |
| IE 10 | 92.0 | 122.3 | 0.33 | ∘ | ∘ |
| IE 11 | 84.6 | 114.2 | 0.35 | ∘ | ∘ |
| IE 12 | 89.1 | 126.5 | 0.42 | ∘ | ∘ |
| IE 13 | 86.5 | 126.3 | 0.46 | ∘ | ∘ |
| IE 14 | 81.2 | 123.4 | 0.52 | ∘ | ∘ |
| IE 15 | 74.1 | 114.9 | 0.55 | ∘ | ∘ |
| CE 12 | 72.3 | 112.8 | 0.56 | □ | □ |
| CE 13 | 82.5 | 129.5 | 0.57 | □ | x |
| CE 14 | 78.4 | 123.9 | 0.58 | x | x |
| CE 15 | 81.4 | 130.2 | 0.60 | x | x |

As shown in Tables 7 and 8, in the case of exemplary embodiments 1 to 15, it is possible to obtain good welding wire feedability and arc stability by appropriately managing a drawing speed and a method of applying bending rollers and straightening rollers after final drawing to maintain a hardening factor within a range of 0.25-0.55, as described in a method of manufacturing welding wire.

Meanwhile, in the case of comparative examples 1 to 4, and 10 and 11, although the drawing speed according to each manufacturing method is appropriate, rollers are inappropriately selected after the final drawing, thereby failing to obtain a hardening factor in an appropriate range. That is, after the final drawing, the bending rollers and the straightening rollers are not used, and only the longitudinal/lateral straightening rollers are used, thereby making the strain hardening rate too low. Therefore, elastic sections increase, making the hardening factor also too low.

When welding is performed with a high feed load, it is difficult to deform the wire through the welding cable. Eventually, when the wire passes through the feeding cable during welding, a large feeding resistance is generated. Therefore, feedability of the welding wire becomes unstable, and arc stability deteriorates.

In comparative examples 5, 7 to 9, and 13 to 15, the drawing speed according to the manufacturing method is too fast, and thus the strain hardening rate of the wire is increased. In addition, when the bending rollers and the straightening rollers are applied after the final drawing, the strain hardening rate is further increased, causing the hardening factor to exceed an appropriate upper limit value. Therefore, excessive increase in strain hardening rate causes relative reduction of the elastic sections. As a result, when welding is performed with a high feed load, the wire is readily bent inside the welding cable, thereby generating arc cut and feed inferiority and deteriorating arc stability.

Meanwhile, in comparative examples 6 and 12, the drawing speed is too low such that the strain hardening rate is too low and the elastic section is relatively large. However, in the case of the 2-step drawing method, the strain hardening rate is high due to the bending rollers and the straightening rollers after the final drawing. Therefore, though the strain hardening rate is low during drawing, it is considerably increased by the bending rollers and the straightening rollers after the final drawing, thus causing a large hardening factor. As a result, it will be appreciated that the wire is easily bent within the welding cable when welding is performed with a high feed load, thereby generating feed inferiority and deteriorating arc stability.

As can be seen from the foregoing, chemical composition, drawing method, and drawing speed of welding wire can be controlled to manage tensile strength of the wire and a hardening factor of the resulting wire within a range of 0.25-0.55, using a combination of bending rollers and straightening rollers, thereby obtaining good welding wire feedability and arc stability.

Although the present invention has been described with reference to certain exemplary embodiments thereof, it will be understood by those skilled in the art that various modifications may be made thereto without departing from the spirit and scope of the present invention defined by the appended claims and their equivalents.

What is claimed is:

1. A solid wire for gas shielded arc welding having a hardening factor, defined by the following Formula 1, within a range of 0.25-0.55,
[Formula 1]
Hardening factor=(maximum tensile strength−yield strength)/yield strength
wherein, the yield strength represents 0.05% offset yield strength.

2. The solid wire for gas shielded arc welding according to claim 1, wherein the wire comprises 0.03-0.10 wt % C, 0.45-1.05 wt % Si, 0.90-1.90 wt % Mn, 0.030 wt % or less P, 0.030 wt % or less S, and residual Fe and other impurities.

3. The solid wire for gas shielded arc welding according to claim 1 or 2, wherein the hardening factor of the solid wire is controlled by a combination of at least one selected from bending rollers and inclined straightening rollers, and longitudinal/lateral straightening rollers.
